(19) United States
(12) Patent Application Publication
(10) Pub. No.: US 2025/0299442 A1
(43) Pub. Date: Sep. 25, 2025

(54) DYNAMIC IMAGE RECONSTRUCTION USING PHYSICS-INFORMED NEURAL NETWORK

(71) Applicant: INTERNATIONAL BUSINESS MACHINES CORPORATION, ARMONK, NY (US)

(72) Inventors: Arka Daw, Blacksburg, VA (US); Kyong Min Yeo, Scarsdale, NY (US); LEVENTE KLEIN, Tuckahoe, NY (US)

(21) Appl. No.: 18/610,650

(22) Filed: Mar. 20, 2024

(51) Int. Cl. G06T 17/05

(52) U.S. Cl. CPC G06T 17/05

(57) ABSTRACT

According to one embodiment, a method, computer system, and computer program product for dynamic image reconstruction is provided. The present invention may include training a physics-informed neural network (PINN) using received training data; receiving wind field velocity measurements in a geographical domain from one or more weather information sources and air pollutant concentration measurements of one or more air pollutants from the geographical domain using a sparse sensor network to produce a plurality of input data; processing the plurality of input data through multiple physics-informed masked convolutional layers in the trained PINN to perform a three-dimensional partial convolution process; and performing the dynamic image reconstruction on the processed plurality of input data using the trained PINN to generate a reconstructed continuous spatial map of the geographical domain.

### BACKGROUND

The present invention relates, generally, to the field of computing, and more particularly to physics-informed neural networks (PINNs).

PINNs are a type of neural network that encode model equations, such as Partial Differential Equations (PDE), as a component of the neural network itself by constraining the network to follow the known physical laws. Thereby, PINNs can embed the knowledge of any physical law that governs a given dataset during the training of the network. Moreover, PINNs consider the physics of a problem rather than attempting to deduce the solution based solely on the available data.

### SUMMARY

Embodiments of a method, a computer system, and a computer program product for dynamic image reconstruction are described. According to one embodiment, a method, computer system, and computer program product for dynamic image reconstruction may include training a physics-informed neural network (PINN) using received training data; receiving wind field velocity measurements in a geographical domain from one or more weather information sources and air pollutant concentration measurements of one or more air pollutants from the geographical domain using a sparse sensor network to produce a plurality of input data; processing the plurality of input data through multiple physics-informed masked convolutional layers in the trained PINN to perform a three-dimensional partial convolution process; and performing the dynamic image reconstruction on the processed plurality of input data using the trained PINN to generate a reconstructed continuous spatial map of the geographical domain.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating a physics-informed neural network dynamic image reconstruction process according to at least one embodiment.

FIG. 3 is an illustration of a three-dimensional partial convolution mask creation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of computing, and in particular to physics-informed neural networks (PINNs). The present embodiment has the capacity to improve spatial mapping of climate change data. The present embodiment can perform a three-dimensional partial convolution process on sparse point input time-series data across a geographical domain using a trained PINN and can reconstruct a spatial map of the geographical domain to display a contiguous time-series spatial map of the geographical domain.

Currently, the reconstruction of spatial maps using sparse point measurements is performed using Kriging or other interpolation methods. Kriging methods, including Ordinary, Universal, CoKriging, and Indicator Kriging, are spatial interpolation methods based on statistical approaches that estimate values at unknown points based on the values at known points. However, Kriging methods often produce unreliable and undesirable spatial maps when a spatial structure contains missing pixels or outliers in its input image. Additionally, current methods use convolution neural networks to perform spatial mapping. However, complete data acquisition for many complex real-world phenomena remains intractable because purely data-driven approaches present difficulties when the data is scarce or insufficient for the complexity of the problem. Furthermore, many scientific problems also have to satisfy certain physical principles, such as conservation of mass, conservation of energy, and conservation of momentum, which is not guaranteed when using traditional machine learning techniques. Thus, an implementation of spatial mapping is needed, in which the entirety of a spatial map of a geographical domain is reconstructed from sparse data points while implementing the known physical laws into the reconstruction process.

Thus, embodiments of the present invention may provide advantages including, but not limited to, performing spatial mapping of climate change data in a geographical domain where data fidelity to a physics-based simulation is preserved. The present invention can process sparse air pollutant concentration measurements and wind field velocity measurements in a geographical domain through multiple physics-informed masked convolutional layers in a trained PINN, thereby, ensuring that the reconstruction process is governed by the known physical laws. Also, the present invention can perform a three-dimensional partial convolution process in which the trained PINN can gradually fill in the missing areas in the feature map of the geographical domain from the locations of sensors until the whole domain is filled up, thereby, ensuring that the entirety of the spatial map is filled in regardless of the availability of input data. Additionally, the present invention can identify the source locations of the air pollutants in the geographical domain, as well as the estimate emission magnitudes of the air pollutants at multiple locations within the geographical domain, thereby, solving both the forward problem, through predicting plume dynamics from known initial conditions and model parameters, and the inverse problem, through inferring initial conditions (i.e. locations of the sources) and model parameters (i.e. emission magnitudes) from observations. The present invention does not require that all advantages need to be incorporated into every embodiment of the invention.

An exemplary embodiment of the present invention comprises the physics-informed neural network beginning to perform dynamic image reconstruction close to the locations of the sensors in the geographic domain and gradually growing the reconstruction outward as the three-dimensional partial convolution mask expands to cover progressively more area of the geographic domain. The mask shape can change as wind direction changes. Additionally, the mask size and shape can be altered based on the received wind field velocity measurements and air pollutant concentration measurements.

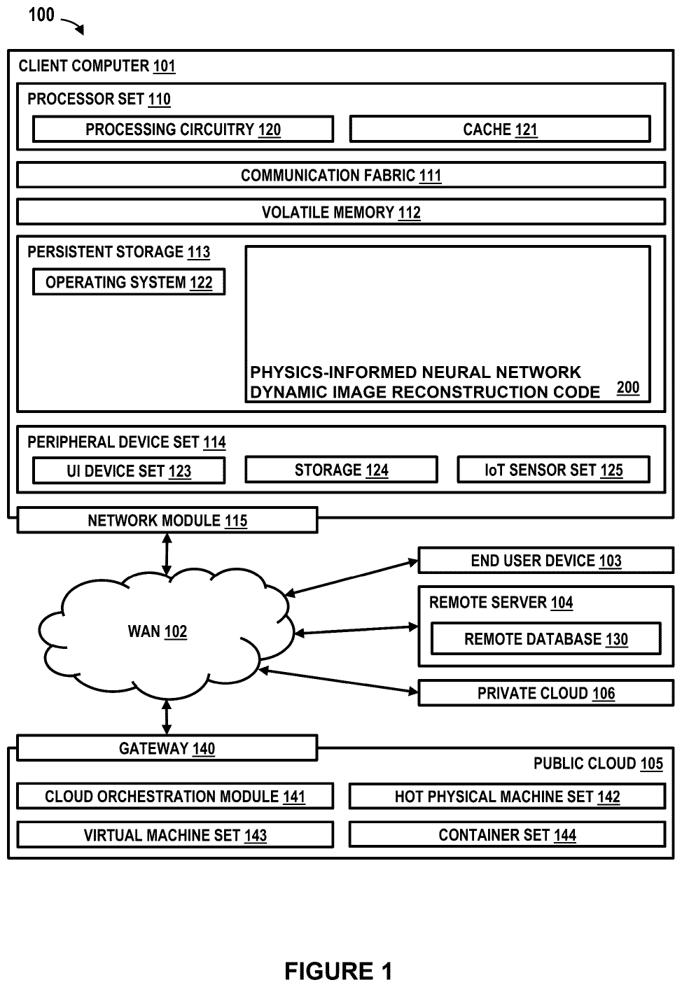

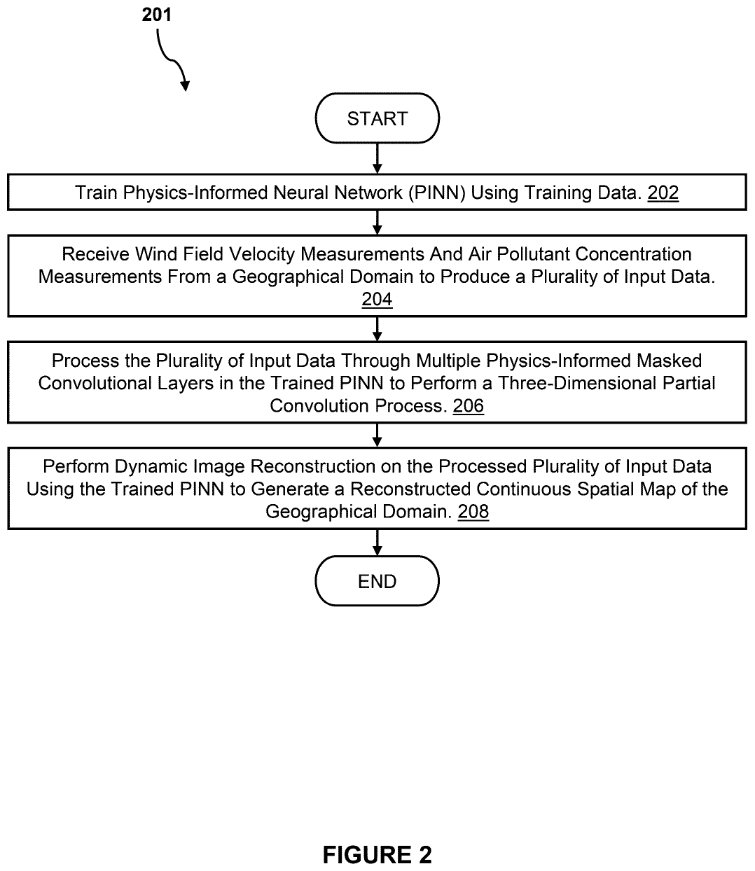

The embodiments mentioned in this paragraph are further illustrated and described below in the discussions of FIGS. 1 and 2. According to at least one embodiment, the program trains a physics-informed neural network (PINN) using received training data. Also, the program receives wind field velocity measurements in a geographical domain from one or more weather information sources and air pollutant concentration measurements of one or more air pollutants from the geographical domain using a sparse sensor network to produce a plurality of input data. Furthermore, the program processes the plurality of input data through multiple physics-informed masked convolutional layers in the trained PINN to perform a three-dimensional partial convolution process. Moreover, the program performs a dynamic image reconstruction on the processed plurality of input data using the trained PINN to generate a reconstructed continuous spatial map of the geographical domain.

According to at least one other embodiment, the program further performs the three-dimensional partial convolution process by applying a three-dimensional partial convolution mask to the plurality of input data during each pass through each of the multiple physics-informed masked convolutional layers, and updating the three-dimensional partial convolution mask during each pass of the plurality of input data through each of the multiple physics-informed masked convolutional layers. According to at least one other embodiment, the program further performs the three-dimensional partial convolution process by generating a diffusion mask using the plurality of input data during each pass of the plurality of input data through each of the multiple physics-informed masked convolutional layers, and generating a drift mask using the plurality of input data during each pass of the plurality of input data through each of the multiple physics-informed masked convolutional layers.

According to at least one other embodiment, the program trains the PINN using the received training data by propagating a physics-informed neural network loss contribution through the PINN. According to at least one other embodiment, the program further performs the three-dimensional partial convolution process by generating an emissions characteristic vector, wherein the emissions characteristic vector represents one or more source locations of the one or more air pollutants in the geographical domain and the emission magnitudes of the one or more air pollutants at one or more locations in the geographical domain. According to at least one other embodiment, the PINN comprises an encoder and two decoders, wherein the encoder and one of the two decoders comprise the multiple physics-informed masked convolutional layers, and wherein an other one of the two decoders comprises a multi-layered perceptron. According to at least one other embodiment, the program trains the PINN using the received training data by incorporating atmospheric diffusion into the multiple physics-informed masked convolutional layers using an Advection-Diffusion Equation.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to train a physics-informed neural network (PINN) using received training data, receive wind field velocity measurements in a geographical domain from one or more weather information sources and air pollutant concentration measurements of one or more air pollutants from the geographical domain using a sparse sensor network to produce a plurality of input data, process the plurality of input data through multiple physics-informed masked convolutional layers in the trained PINN to perform a three-dimensional partial convolution process, and perform the dynamic image reconstruction on the processed plurality of input data using the trained PINN to generate a reconstructed continuous spatial map of the geographical domain.

Referring to FIG. 1, an exemplary networked computer environment 100 is depicted, according to at least one embodiment. Computing environment 100 contains an example of an environment for the execution of at least some of the computer code involved in performing the inventive methods, such as physics-informed neural network dynamic image reconstruction code 200, also referred to as “Physics-informed neural network dynamic image reconstruction program 200”, or “the program 200”. In addition to code block 200 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, peripheral device set 114 may include a sensor network 114 comprising one or more sensors 114, such as air/air quality sensors 114 for measuring air pollutants, such as methane, carbon monoxide, ammonia, nitric oxide, nitrogen dioxide, ozone, particulate matter, sulfur dioxide, or volatile organic compounds. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 can store outputted data from the PINN, such as reconstructed concentration fields, pollutant source location information, and emission magnitude data. The database 130 can comprise received wind field velocity measurements and air pollutant concentration measurements. Additionally, the database 130 can comprise the physics-informed neural network (PINN). Also, the database 130 can comprise uploaded training data received though simulations, satellite observations, or sensor 114 measurements.

According to the present embodiment, the neural network dynamic image reconstruction program 200 may be a program capable of training a physics-informed neural network (PINN) using received training data. Also, the program 200 may be a program capable of receiving wind field velocity measurements and air pollutant concentration measurements of one or more air pollutants from the geographical domain to produce a plurality of input data. Additionally, the program 200 may be a program capable of processing the plurality of input data through multiple physics-informed masked convolutional layers in the trained PINN to perform a three-dimensional partial convolution process. Furthermore, the program 200 may be a program capable of performing the dynamic image reconstruction on the processed plurality of input data using the trained PINN to generate a reconstructed continuous spatial map of the geographical domain for the air pollutant distribution across the domain. The program 200 may be located on client computing device 101 or remote server 104 or on any other device located within network 102. Furthermore, the program 200 may be distributed in its operation over multiple devices, such as client computing device 101 and remote server 104. The physics-informed neural network dynamic image reconstruction method is explained in further detail below with respect to FIG. 2.

Referring now to FIG. 2, an operational flowchart illustrating a physics-informed neural network dynamic image reconstruction process 201 is depicted according to at least one embodiment. At 202, the program 200 trains a physics-informed neural network with received training data. The program 200 can receive uploaded labeled time-series and point-wise training data from the database 130. The training data can comprise initial input training data, as well as target training data. The initial input training data can comprise three-dimensional arrays representing both wind field velocity measurements and air pollutant concentration measurements in a predefined geographical domain. The wind field velocity measurements can be two-dimensional arrays representing the wind field velocity measurements, stored sequentially in time. Also, the wind field velocity measurements may comprise a horizontal layer from a three-dimensional weather station network, satellite, or numerical weather models. The program 200 can represent the wind field velocity measurements as [Time×Latitude×Longitude]. The air pollutant concentration measurements can be two-dimensional arrays representing the concentration measurements of air pollutants at the locations of the sensors 114 in the predefined geographical domain, stored sequentially in time. The program 200 can represent the air pollutant concentration measurements as [Time×Sensor Measurements]. The concentration of air pollutants can be acquired at different heights above the ground and can be adjusted through known physical parameter variations in space to represent the measurements in the field of wind data.

The target training data can comprise three-dimensional arrays representing reconstructed concentration field data, as well as one-dimensional arrays representing the source locations of air pollutants and the emission magnitudes of the air pollutants, throughout the predefined geographical domain. The reconstructed concentration field data can be two-dimensional arrays representing concentration field data, stored sequentially in time, in the predefined geographical domain. The program 200 can represent the reconstructed concentration field data as [Time×Latitude×Longitude]. Also, the program 200 can represent the source locations of the air pollutants, and the emission magnitudes of the air pollutants as one-dimensional arrays of size S×S. The program 200 can represent the number of disjoint cells in each direction of a two-dimensional spatial domain of the predefined geographical domain as S. The source locations of the air pollutants can comprise an east-west location of the source of a pollutant, a south-north location of the source of a pollutant source, and a probability of a disjointed cell containing a source of a pollutant. Additionally, the training data can comprise a data set of collocation points that enforce the initial conditions of the Advection Diffusion Equation and the boundary conditions of the Advection Diffusion Equation, as well as fulfill the Advection Diffusion Equation.

The PINN can comprise an encoder-decoder architecture, including an encoder and two decoders, referred to as the first decoder and the second decoder respectively. The encoder and the first decoder can each comprise several physics-informed masked convolutional layers. A physics-informed masked convolutional layer can comprise a drift mask generator module, a diffusion mask updater module, and a three-dimensional masked convolution module. The second decoder can comprise a single multi-layered deep neural network, such as a multi-layered perceptron (MLP). Additionally, the PINN may comprise one or more skip connections between layers of the encoder and layers of the first decoder. The PINN may use skip connections to directly feed the output of a physics-informed masked convolutional layer in the encoder as input into a layer of the first decoder.

The program 200 can train the PINN through a supervised learning process by passing the training data through the PINN. The program 200 can train the encoder to output latent representations, otherwise known as small-scale vectors, of an input image. The program 200 can train the first decoder of the PINN to output a reconstructed concentration field of the geographical domain by decoding the latent feature representations. Also, the program 200 can train the second decoder of the PINN to output the source locations of the air pollutants, as well as the emission magnitudes of the air pollutants. During the training process, the PINN convolutional layers can learn a hidden feature space. The learned hidden feature space can be constrained by designing a physics-informed masked three-dimensional convolutional layer that can explicitly encode a physics-based inductive bias into the three-dimensional masked convolution module. The PINN can incorporate the atmospheric diffusion into the three-dimensional masked convolution module using the following Advection-Diffusion Equation:

$$\frac{{ϑ}_{ϕ}}{{ϑ}_{t}} + u {∇}_{ϕ} - K {∇}_{ϕ}^{2} = {\sum }_{t = 1}^{{N}_{s}} {q}_{t} ( x , t )$$

The PINN can represent the number of potential air pollutant emission sources as Nₛ. The PINN can represent the number of sensors 114 within a geographical domain as Nₒ. The PINN can represent the wind field velocity as u. The PINN can represent a discrete mesh as size Nₓ×N_{y}. Each disjoint cell may comprise a discrete x and y component of the wind. The PINN can represent the concentration of a pollutant as ϕ. The PINN can represent the turbulent diffusivity as K. The PINN can represent the emission magnitudes of the i-th score as qₜ(x, t). In at least one embodiment, the PINN determines the wind field velocity to be divergence-free, and thus, sets ∇u=0.

Additionally, the program 200 trains the PINN by introducing a physics-informed loss contribution. Introducing a physics-informed loss contribution enforces the Advection-Diffusion on the regular grid. Also, the program 200 may incorporate multi-task consistency in the physics-informed loss function learning process. The PINN can incorporate multi-task consistency by sharing features learned through the PINN training process, such as the reconstructed concentration spatial map, the locations of the sensors 114, and the emission magnitudes of the air pollutants, between tasks to enhance predictions in comparison to learning each task independently. The program 200 can determine the physics-informed neural network loss contribution using the target training data. A simplified representation of the formula for calculating the physics-informed neural network loss contribution can be:

$$ℒ = {ℒ}^{r e c o n} + {λ}_{1} {ℒ}^{i n v e r s e}$$

The PINN can represent the physics-informed loss function as [symbol] . The PINN can represent the reconstruction loss as [symbol] . The PINN can represent the inverse loss as [symbol] . The PINN can represent the scalar which is used to control the emphasis on the inverse loss as λ₁. The PINN can compute the reconstruction loss, such as a mean square error loss function, using the following formula:

$${ℒ}^{r e c o n} = \frac{1}{2} {𝔼}_{x ∼ {p}_{data}} [ log {σ}^{2} + \frac{{( {ϕ}_{true} - {ϕ}_{μ} )}^{2}}{{σ}^{2}} ]$$

The PINN can represent the uncertainty of the neural network's prediction as σ. The PINN can compute the inverse loss using the following formula:

$${ℒ}^{i n v e r s e} = {λ}_{s r c} {\sum }_{i = 1}^{{s}^{2}} [ {( {x}_{i}^{s} - \hat{{x}_{ι}} )}^{2} + {( {y}_{i}^{s} - \hat{y} )}^{2} ] + {λ}_{s r c} {\sum }_{i = 1}^{{s}^{2}} {1}_{i j}^{s r c} [ ( {σ ( {\hat{p}}_{i} - 1 )}^{2} ] + {λ}_{n o s r c} {\sum }_{i = 1}^{{s}^{2}} {𝟙}_{i j}^{n o s r c} [ {( σ ( {\hat{p}}_{i} ) )}^{2} ] + {λ}_{s r c} {\sum }_{i = 1}^{{s}^{2}} {1}_{i j}^{s r c} [ {( {c}_{i} - Softplus ( {\hat{c}}_{i} ) )}^{2} ]$$

The PINN can represent the first indicator function as [symbol] . The PINN can set the first indicator function, [symbol] , equal to one (1) if the location of the j-th air pollutant source is in the i-th cell and equal to zero (0) otherwise. The PINN can represent the second indicator function as [symbol] . The PINN can set the second indicator function, [symbol] , equal to zero (0) if the location of the j-th air pollutant source is in the i-th cell and equal to one (1) otherwise. The PINN can represent the probability that the air pollutant source is located within one of the disjoining cells as \hat{p}. As previously stated, the PINN can represent the number of disjoint cells in each direction of the two-dimensional spatial domain of the predefined geographical domain as S. The PINN can represent the east-west location of an air pollutant source in a disjoint cell as \hat{x}. The PINN can represent the south-north location of an air pollutant source in a disjoint cell as ŷ. The PINN can represent the probability of a disjointed cell containing an air pollutant source as \hat{p}. The PINN can represent the emission magnitudes of an air pollutant in the disjoint cell as c. The program 200 can train the PINN with the computed physics-informed loss function, [symbol] , using a backpropagation mechanism to propagate the loss function into the PINN's physics-informed masked convolutional layers.

At 204, the program 200 receives wind field velocity measurements and air pollutant concentration measurements from a geographical domain to produce a plurality of input data. The geographical domain can be defined by a region surrounding the various locations where the sensors 114, collectively referred to as the sparse sensor 114 network, are positioned. The program 200 can receive the wind field velocity measurements of the geographical domain from one or more weather information models/systems, such as The High-Resolution Rapid Refresh (HRRR) or the Global Forecast System (GFS). Also, the program 200 may receive the wind field velocity measurements of the geographical domain from one or more weather and satellite stations. The weather information models/systems and the weather and satellite stations can collectively be referred to as the “weather information sources”. The program 200 can receive concentration measurements of air pollutants, such as methane, carbon monoxide, ammonia, nitric oxide, nitrogen dioxide, ozone, particulate matter, sulfur dioxide, or volatile organic compounds, from one or more air/air quality sensors 114. Also, the program 200 may receive the air pollutant concentration measurements from satellite observations. The sensors 114 can measure the time-series concentrations of the air pollutants present at each location of a sensor 114 by continuously scanning their surrounding environment, such that a time history of the present concentrations at each sensor 114 location exists. The program 200 may continuously receive the wind field velocity measurements and air pollutant concentration measurements comprised within a multi-channel image composed of sequential images obtained along the time domain from the sensors 114 through data acquisition. As previously stated, the wind field velocity measurements, u, can comprise three-dimensional arrays made up of two-dimensional representations of wind field velocity, stored sequentially in time. The air pollutant concentration measurements, ϕ, can comprise three-dimensional arrays made up of two-dimensional representations of the concentration sensor 114 measurements, stored sequentially in time.

At 206, the program 200 processes the plurality of input data through multiple physics-informed masked convolutional layers in the trained PINN to perform a three-dimensional partial convolution process. The three-dimensional partial convolution process can comprise repeatedly feeding and processing the multi-channel image using the physics-informed masked convolutional layers and downsample layers to aggregate the received wind field velocity measurements and air pollutant concentration measurements over the whole imaging space of the geographical domain, such that a feature map is gradually expanded from the locations of the sensors 114 on the map to the edges of the map during each pass through a physics-informed masked convolutional layer until the whole domain is filled-up.

The program 200 can input the received multi-channel image into the trained PINN. The PINN can feed the multi-channel image into the first physics-informed convolutional layer. The trained PINN can extract both the spatial and temporal domain features from the multi-channel image simultaneously. The spatial and temporal domain features can comprise the wind field velocity and air pollutant concentration measurements. The physics-informed masked convolutional layer can generate a three-dimensional convolution mask as a combination of a diffusion and drift-based linear combination of masks that incorporate dominant physics, such as atmospheric diffusion, through the training process with the Advection Diffusion Equation. The three-dimensional convolution mask can evolve through a partial convolution process in two ways: (1) a time-invariant diffusion component that mimics the process of physical diffusion by isotropically dispersing the mask in the space; and (2) a time-dependent drift component that captures the process of advection by making the mask a function of the wind field velocity.

The PINN can generate an initial input mask, M₀, using the following formula:

$$( {M}_{0} ( x ) ) = \{ \begin{matrix}1 , & if x ∈ {x}^{Φ} \\ 0 , & otherwise\end{matrix}$$

The initial mask can have a value of one (1) at the absolute location of the sensors 114, and a value of zero (0) at all other locations in the geographical domain. The PINN can input the initial mask into the diffusion mask updater to generate a diffusion mask. The diffusion mask can represent the spread of the concentration of an air pollutant in the domain isotropically. For the diffusion mask, the spread of the concentration does not depend on the dimensions of the geographical domain. The diffusion mask process can be modeled as a time-invariant process. A time-invariant process depends only on the current spatial geometry of the mask.

The PINN can feed the initial input mask, M, into the diffusion mask updater to output the diffusion mask, M^{diffusion}. The PINN can compute Wₖ^{diffusion} (i,j) using the following formula:

$${W}_{k}^{diffusion} ( i , j ) = exp ( - \frac{1}{2 {σ}_{k}^{2}} [ {( i - \frac{k - 1}{2} )}^{2} + {( j - \frac{k - 1}{2} )}^{2} ] ) ; i , j ∈ \{ 0 , 1 , … , k - 1 \}$$

The PINN can use a Gaussian kernel with a learnable parameter and can represent the learnable parameter as σₖ. The PINN can represent the index of the pixels in the input mask as i, j and k. The PINN can compute the diffusion mask using the following formula:

M^{diffusion}=(Wₖ^{diffusion})^{T}M

Additionally, the PINN can input the wind field velocity measurements, u, into the drift mask generator module to output the drift mask, M^{drift}. The drift mask can represent the spread of the measured concentration following the direction and magnitude of the wind (i.e. the size and shape of the drift mask is determined by the wind direction and its magnitude). The drift mask, unlike the diffusion mask, can be purely a temporal phenomenon (i.e. the position of a particle at time t+1 depends on the drift velocity from time t). The PINN can compute the drift mask by combining the forward-in-time drift, M^{f}, also referred to as the forward advection, and the backward-in-time drift, M^{b}, also referred to as the adjoint advection, using the following formula:

$${M}^{drift} = {M}^{f} + {M}^{b}$$

The forward-in-time drift, M^{f}, can represent the forward wind field velocity. The PINN can compute the forward-in-time drift, M^{f}, using the following formula:

$${M}_{i , j , t}^{f} = {\sum }_{k , {k}^{′} = - l}^{l} {M}_{i + k , j + {k}^{′} , t - 1} exp [ - \frac{1}{2 {σ}_{v}^{2}} {‖ δ {x}_{k , {k}^{′}} - {u}_{i + k , j + {k}^{′} , t - 1} δ t ‖}_{2}^{2} ]$$

The PINN can use a Gaussian kernel with a learnable parameter and can represent the learnable parameter as σᵥ. The PINN can represent the time-step size between each taken measurement by the sensors 114 as δt. The PINN can compute δx_{k,k′} using the following formula:

$$δ {x}_{k , k}^{′} = {x}_{i , j} - {x}_{i - k , j - {k}^{′}}$$

The backward-in-time drift, M^{b}, can represent the reverse wind direction. The PINN can compute the backward in-time drift, M^{b}, using the following formula:

$${M}_{i , j , t}^{b} = {\sum }_{k , {k}^{′} = - l}^{l} {M}_{i + k , j + {k}^{′} , t + 1} exp [ - \frac{1}{2 {σ}_{v}^{2}} {‖ δ {x}_{k , {k}^{′}} - {u}_{i + k , j + {k}^{′} , t + 1} δ t ‖}_{2}^{2} ]$$

The PINN can combine the drift mask, M^{drift}, and the diffusion mask, M^{diffusion}, to generate an updated input mask, M′. The PINN can combine the drift mask, M^{drift}, and the diffusion mask, M^{diffusion}, using the following formula:

$${M}^{′} = σ ( α {M}^{diffusion} + β {M}^{drift} )$$

The program can represent scalar learnable parameters, learned by the PINN during the training phase, that control the proportion of the diffusion and drift components as α and β, respectively. The PINN can represent the sigmoid activation as σ. The PINN can set β=1−α.

Additionally, the PINN can apply the three-dimensional partial convolution mask to the input image, X, by processing the input image, X, and the updated input mask, M′, through the three-dimensional masked convolution module to generate an updated feature map, X′. A simplified representation of the formula for applying the three-dimensional partial convolution mask can be:

$$( {x}^{′} ) = \{ \begin{matrix}{W}^{T} ( X ⊙ M ) \frac{Sum ( 1 )}{sum ( M )} , & if sum ( M ) > 0 \\ 0 , & otherwise\end{matrix}$$

During the first partial convolution round, the updated feature map, X′, is equal to the input image, X. Thus, the PINN does not generate a feature map until the input image is processed through the second physics-informed convolutional layer because the updated input mask, M′, is generated as an output of the first physics-informed convolutional layer. As a result, the first opportunity for the PINN to process the updated input mask, M′, alongside the input image, X, in the three-dimensional masked convolution module, exists in the second physics-informed convolutional layer. The PINN can represent the three-dimensional convolution filter as W. The three-dimensional convolution filter can be an array of weights computed by the PINN during the training phase. The PINN can represent the pixel values being convolved as X. The PINN can represent the binary mask which indicates the validness of each pixel value (0 for missing pixels and 1 for valid pixels) as M. The PINN can represent element-wise multiplication as \textcircled{●}. The PINN can represent a scaling factor to adjust the results as the number of valid input values for each convolution varies as

$$\frac{Sum ( 1 )}{sum ( M )} .$$

The PINN can represent a matrix of ones as 1 that has the same shape as M.

The PINN can further feed the updated feature map, X′, and the updated input mask, M′, into the next physics-informed masked convolutional layer to continue the three-dimensional partial convolution process. During the second partial convolution round, the PINN can process the data as in the first partial convolution round, except that the updated input mask, M′, from the first physics-informed masked convolutional layer will be the input to the diffusion mask updater module and the updated feature map, X′, still representing only the input image, X, will be processed alongside the updated input mask, M′, through the three-dimensional masked convolution module to generate an updated feature map, X′, that displays the extracted spatial and temporal domain features from the input image. During the third, and subsequent, partial convolution rounds, the PINN can process the data as in the second partial convolution round, except that the PINN generates an updated feature map, X′, using the updated feature map, X′, from the previous physics-informed masked convolutional layer, and not the updated feature map, X′, representing only the input image, X. Thus, at each subsequent physics-informed masked convolutional layer, the PINN can generate a further updated input mask, M′, by combining the updated drift mask and the updated diffusion mask. Additionally, at each subsequent physics-informed masked convolutional layer, the PINN can generate a further updated feature map, X′, by processing the previously updated feature map, X′, and the updated input mask, M′, into the three-dimensional masked convolution module. With each pass through a physics-informed masked convolutional layer, the PINN can gradually fill in the missing areas in the updated feature map, X′, from the locations of the sensors 114 on the map to the edges of the map until the whole domain is filled-up. The PINN can repeatedly feed the updated feature map, X′ and the updated input mask, M′, from each physics-informed masked convolutional layer into a subsequent physics-informed masked convolutional layer to continue the partial convolution process until the entire feature map is filled in. The PINN can determine that the entire feature map is filled in upon the updated input mask, M′, comprising all pixel values of ones and no pixel values of zeros.

At 208, the program 200 performs dynamic image reconstruction on the processed plurality of input data using the trained PINN to generate a reconstructed continuous spatial map of the geographical domain. Additionally, the trained PINN can identify the source locations of the air pollutants in the geographical domain that are continuously or intermittently emitting an air pollutant, as well as the emission magnitudes of the air pollutants at multiple locations within the geographical domain. The encoder may output the latent representation, z, otherwise known as a small-scale vector, of the filled-in feature map. The PINN can separately feed the latent representation, z, of the filled-in feature map into both the first decoder and the second decoder.

The first decoder can output a reconstructed concentration spatial map, \hat{ϕ}, by transforming the latent representation, z, into multiple three-dimensional arrays, a three-dimensional array (μ), and a three-dimensional array (σ). The three-dimensional array (μ) may comprise two-dimensional field representations of concentration measurements, stored sequentially in time. The three-dimensional array (σ) may comprise two-dimensional field representations of the uncertainty of the concentration measurements, stored sequentially in time. The PINN can reconstruct a spatial map of the geographical domain by performing spatiotemporal mapping on the three-dimensional arrays to display the data on a contiguous time-series map of the geographical domain.

Additionally, the PINN can feed the latent representation, z, of the filled-in feature map through the second decoder. The second decoder can output an emission characteristics vector, \hat{ξ}, by transforming the latent representation, z, into one-dimensional arrays of size, S×S. The emission characteristics vector, \hat{ξ}, can represent the source locations of the pollutants and the emission magnitudes (concentrations) of the pollutants. As previously stated, the PINN can represent the number of disjoint cells in each direction of the two-dimensional spatial domain of the predefined geographical domain as S. The PINN can represent the east-west location of a pollutant source in a disjoint cell as \hat{x}. The PINN can represent the south-north location of a pollutant source in a disjoint cell as ŷ. The PINN can represent the probability of a disjointed cell containing a pollutant source as \hat{p}. The PINN can represent the emission magnitudes of a pollutant in the disjoint cell as c.

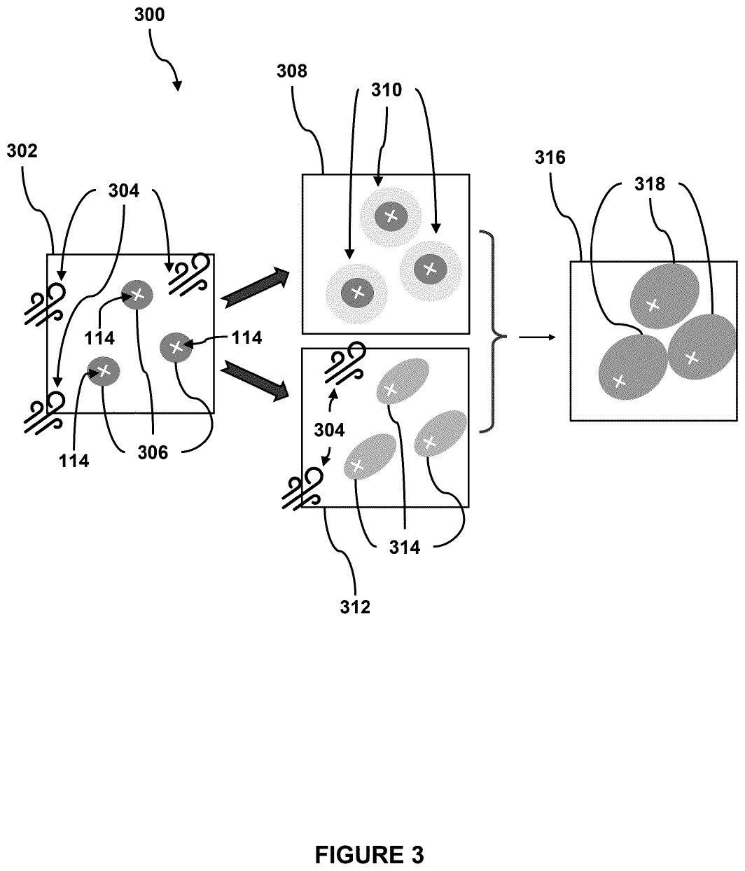

Referring now to FIG. 3, a three-dimensional partial convolution mask creation process 300 is depicted according to at least one embodiment. A feature map of a geographical domain 302 including the locations of the sensors 114, the wind field velocity components 304, and the initial mask 306 is depicted. Also, the feature map of a geographical domain 308 including the generated diffusion mask 310 is depicted. Furthermore, the feature map of a geographical domain 312 including the wind field velocity components 304 and the generated drift mask 314 is depicted. Additionally, the feature map of a geographical domain 316 including the updated mask 318, generated by combining the generated diffusion mask 312 and the generated drift mask 314, is depicted.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamic image reconstruction, the method comprising:
training a physics-informed neural network (PINN) using received training data;
receiving wind field velocity measurements in a geographical domain from one or more weather information sources and air pollutant concentration measurements of one or more air pollutants from the geographical domain using a sparse sensor network to produce a plurality of input data;
processing the plurality of input data through multiple physics-informed masked convolutional layers in the trained PINN to perform a three-dimensional partial convolution process; and
performing the dynamic image reconstruction on the processed plurality of input data using the trained PINN to generate a reconstructed continuous spatial map of the geographical domain.

2. The method of claim 1, wherein performing the three-dimensional partial convolution process further comprises:
applying a three-dimensional partial convolution mask to the plurality of input data during each pass through each of the multiple physics-informed masked convolutional layers; and
updating the three-dimensional partial convolution mask during each pass of the plurality of input data through each of the multiple physics-informed masked convolutional layers.

3. The method of claim 2, wherein performing the three-dimensional partial convolution process further comprises:
generating a diffusion mask using the plurality of input data during each pass of the plurality of input data through each of the multiple physics-informed masked convolutional layers; and
generating a drift mask using the plurality of input data during each pass of the plurality of input data through each of the multiple physics-informed masked convolutional layers.

4. The method of claim 1, wherein training the PINN using the received training data comprises propagating a physics-informed neural network loss contribution through the PINN.

5. The method of claim 1, wherein performing the three-dimensional partial convolution process further comprises:
generating an emissions characteristic vector, wherein the emissions characteristic vector represents one or more source locations of the one or more air pollutants in the geographical domain and emission magnitudes of the one or more air pollutants at one or more locations in the geographical domain.

6. The method of claim 1, wherein the PINN comprises:
an encoder and two decoders;
wherein the encoder and one of the two decoders comprise the multiple physics-informed masked convolutional layers; and
wherein an other one of the two decoders comprises a multi-layered perceptron.

7. The method of claim 1, wherein training the PINN using the received training data comprises incorporating atmospheric diffusion into the multiple physics-informed masked convolutional layers using an Advection-Diffusion Equation.

8. A computer system for dynamic image reconstruction, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
training a physics-informed neural network (PINN) using received training data;
receiving wind field velocity measurements in a geographical domain from one or more weather information sources and air pollutant concentration measurements of one or more air pollutants from the geographical domain using a sparse sensor network to produce a plurality of input data;
processing the plurality of input data through multiple physics-informed masked convolutional layers in the trained PINN to perform a three-dimensional partial convolution process; and
performing the dynamic image reconstruction on the processed plurality of input data using the trained PINN to generate a reconstructed continuous spatial map of the geographical domain.

9. The computer system of claim 8, wherein performing the three-dimensional partial convolution process further comprises:
applying a three-dimensional partial convolution mask to the plurality of input data during each pass through each of the multiple physics-informed masked convolutional layers; and
updating the three-dimensional partial convolution mask during each pass of the plurality of input data through each of the multiple physics-informed masked convolutional layers.

10. The computer system of claim 9, wherein performing the three-dimensional partial convolution process further comprises:
generating a diffusion mask using the plurality of input data during each pass of the plurality of input data through each of the multiple physics-informed masked convolutional layers; and
generating a drift mask using the plurality of input data during each pass of the plurality of input data through each of the multiple physics-informed masked convolutional layers.

11. The computer system of claim 8, wherein training the PINN using the received training data comprises propagating a physics-informed neural network loss contribution through the PINN.

12. The computer system of claim 8, wherein performing the three-dimensional partial convolution process further comprises:
generating an emissions characteristic vector, wherein the emissions characteristic vector represents one or more source locations of the one or more air pollutants in the geographical domain and emission magnitudes of the one or more air pollutants at one or more locations in the geographical domain.

13. The computer system of claim 8, wherein the PINN comprises:
an encoder and two decoders;
wherein the encoder and one of the two decoders comprise the multiple physics-informed masked convolutional layers; and
wherein an other one of the two decoders comprises a multi-layered perceptron.

14. The computer system of claim 8, wherein training the PINN using the received training data comprises incorporating atmospheric diffusion into the multiple physics-informed masked convolutional layers using an Advection-Diffusion Equation.

15. A computer program product for dynamic image reconstruction, the computer program product comprising:
one or more computer-readable tangible storage medium and program instructions stored on at least one of the one or more tangible storage medium, the program instructions executable by a processor to cause the processor to perform a method comprising:
training a physics-informed neural network (PINN) using received training data;
receiving wind field velocity measurements in a geographical domain from one or more weather information sources and air pollutant concentration measurements of one or more air pollutants from the geographical domain using a sparse sensor network to produce a plurality of input data;
processing the plurality of input data through multiple physics-informed masked convolutional layers in the trained PINN to perform a three-dimensional partial convolution process; and
performing the dynamic image reconstruction on the processed plurality of input data using the trained PINN to generate a reconstructed continuous spatial map of the geographical domain.

16. The computer program product of claim 15, wherein performing the three-dimensional partial convolution process further comprises:
applying a three-dimensional partial convolution mask to the plurality of input data during each pass through each of the multiple physics-informed masked convolutional layers; and
updating the three-dimensional partial convolution mask during each pass of the plurality of input data through each of the multiple physics-informed masked convolutional layers.

17. The computer program product of claim 16, wherein performing the three-dimensional partial convolution process further comprises:
generating a diffusion mask using the plurality of input data during each pass of the plurality of input data through each of the multiple physics-informed masked convolutional layers; and
generating a drift mask using the plurality of input data during each pass of the plurality of input data through each of the multiple physics-informed masked convolutional layers.

18. The computer program product of claim 15, wherein training the PINN using the received training data comprises propagating a physics-informed neural network loss contribution through the PINN.

19. The computer program product of claim 15, wherein performing the three-dimensional partial convolution process further comprises:
generating an emissions characteristic vector, wherein the emissions characteristic vector represents one or more source locations of the one or more air pollutants in the geographical domain and emission magnitudes of the one or more air pollutants at one or more locations in the geographical domain.

20. The computer program product of claim 15, wherein the PINN comprises:
an encoder and two decoders;
wherein the encoder and one of the two decoders comprise the multiple physics-informed masked convolutional layers; and
wherein an other one of the two decoders comprises a multi-layered perceptron.
